(19) United States
(12) Patent Application Publication
(10) Pub. No.: US 2008/0181210 A1
(43) Pub. Date: Jul. 31, 2008

(54) PROCESSING REGISTER VALUES IN MULTI-PROCESS CHIP ARCHITECTURES

(75) Inventor: Gayle Noble, Boulder Creek, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Finisar Corporation, Sunnyvale, CA (US)

(21) Appl. No.: 11/669,621

(22) Filed: Jan. 31, 2007

(51) Int. Cl. H04L 12/56

(52) U.S. Cl. 370/389; 370/401

(57) ABSTRACT

In a computing environment, a method includes receiving a first data packet at a first kick code from a first stage, the kick code being configured to process data packets individually and the first stage being configured to perform one or more tasks, updating one or more counters using the first kick code based on determinations made in the one or more tasks performed at the first stage; and directing the first data packet to a another stage.

### BACKGROUND OF THE INVENTION

1. The Field of the Invention

The present invention relates generally to the field of network monitoring and analysis and to processing register values in multi-process chip architectures in particular.

2. The Relevant Technology

In an age when television commercials show everyday people effortlessly accessing their bank account's information from a street corner by way of a cell phone, it is ironic that accessing data flowing within its physical source—the network—is, without advanced preparation, nearly impossible. In fact, for many IT organizations the network itself has become an impenetrable black box. In the rush to boost network speeds, most companies have migrated from token ring or other peer-to-peer topologies to switched networks such as Local Area Networks (LANs) and Storage Area Networks (SANs).

While the new technology has yielded the desired result, increased speed, it has made access to the data flowing through connections within the network more difficult. Unlike peer-to-peer networks with their centralized data flows, where access is a matter of acquiring data as a peer node, switched networks have a decentralized structure with no ready access points. Accordingly, when network problems or slowdowns occur, or when monitoring becomes desirable, administrators often do not have the necessary access to network data flows to diagnose problems or to monitor the network.

One possible solution for analyzing the network traffic includes accessing the network with traffic access ports (TAPs). TAPs provide a copy of the network traffic without interrupting the network traffic. The copy of the network traffic provided by a TAP may then be analyzed by a device connected to the TAP, such as a network device. Available network devices may not be optimally configured for use in analyzing the network traffic. One example of a network device that can be used to analyze network traffic is a network switch. Network switches are configured to direct network traffic from different devices to other devices on the network. In directing network traffic, switches often determine which device sent the data and the final destination of the data. However, the standard configuration found in some network switches may have other limitations when analyzing the traffic flow over an entire network or large parts of a network.

### BRIEF SUMMARY OF THE INVENTION

In a computing environment, a method includes receiving a first data packet at a first kick code from a first stage. The kick code being configured to process data packets individually, such as in a first in first out (FIFIO) manner as the data packets are leaving the first stage. The first stage being configured to have many, in fact hundreds of processes running simultaneously to perform one or more tasks, included in these tasks is determining if one or more counters need to be updated using the first kick code based on determinations made in the one or more tasks performed at the first stage. The kick code also determines what further processing stage the packet should be sent to or if it is ready to be sent to an output queue and if so which one. The use of the kick code may increase the speed of processing the packets by reducing or eliminating the use of doing a lock, read-modify, write, unlock to update each of the many counters that hundreds of threads or tasks are attempting to access at the same time as the kick code is configured to process each packet individually.

These and other features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a generalized schematic view of a simplified network according to one example.

FIG. 2 illustrates a schematic view of data processing in a network device according to one example.

### DETAILED DESCRIPTION

A method and system are provided herein for processing register values in multi-process chip architecture. The system and method reduce slow downs in multi-process architectures by reducing or eliminating read-modified writes used to update one or more counters. According to one example the process includes making use of a staging process, sometimes also referred to as “kick code” to update registers. In particular, multi-chip architecture frequently makes use of stages in which multiple pieces of data, such as packets, are processed using similar or identical tasks running in parallel within the stage. Once each task has completed its process, the data is then sent to the kick code, which determines the next stage to which the data should be transferred or “kicked.” For ease of reference, each piece of data will be referred to as a packet. Other types of data may be used.

In order to keep track of what has been achieved at each stage, counters, registers, and/or the like are used. In conventional systems, each task increments the counter before being directed to the kick code. In such conventional approaches, the register being updated is locked so that other tasks that complete around the same time will not be able to access the counter while other tasks are attempting to increment the register at the same time, which may result in corruption of the count within the register. While locking the register helps maintain the accuracy of the counter, locking the register may also significantly slow the process, as locking the register requires additional time compared to updating the register for only a single task.

A method and system are provided herein for processing register values in multi-process chip architecture. The system and method reduce slow downs in multi-process architectures by reducing or eliminating lock, read-modify write, and unlock process used to update one or more counters. In order to update a counter one must lock the access to that memory location, read that location, update the value, such as by adding to or subtracting from the value stored in memory; write the new value back; then unlock the memory. According to one example the process includes making use of a staging process, sometimes also referred to as “kick code” to update unique memory locations, such as registers. Other unique memory locations may also be used, such that references to registers shall be understood to include any type of unique memory location. In particular, multi-chip architecture frequently makes use of stages in which multiple pieces of data, such as packets, are processed using similar or identical tasks running in parallel within the stage. Once each task has completed its process, the data is then sent to the kick code, which determines the next stage to which the data should be transferred or “kicked.” For ease of reference, each piece of data will be referred to as a packet. Other types of data may be used.

Once the counter has been updated, the kick code then processes the next packet, including updating the corresponding counters, if any, and routes the packet to the appropriate next stage. Such a configuration may increase the speed of processing the data relative to each task or process incrementing the registers upon completion. The kick code may be implemented in a device suited for use in networks, such as a network processor. In particular, in one example discussed below, the network processor may be a network switch, such as a programmable Ethernet switch.

Reference will now be made to the figures wherein like structures will be provided with like reference designations. It is understood that the drawings are diagrammatic and schematic representations of presently preferred embodiments of the invention, and are not limiting of the present invention nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of traffic access ports, physical layer switches, and networks have not been described in particular detail in order to avoid unnecessarily obscuring the present invention.

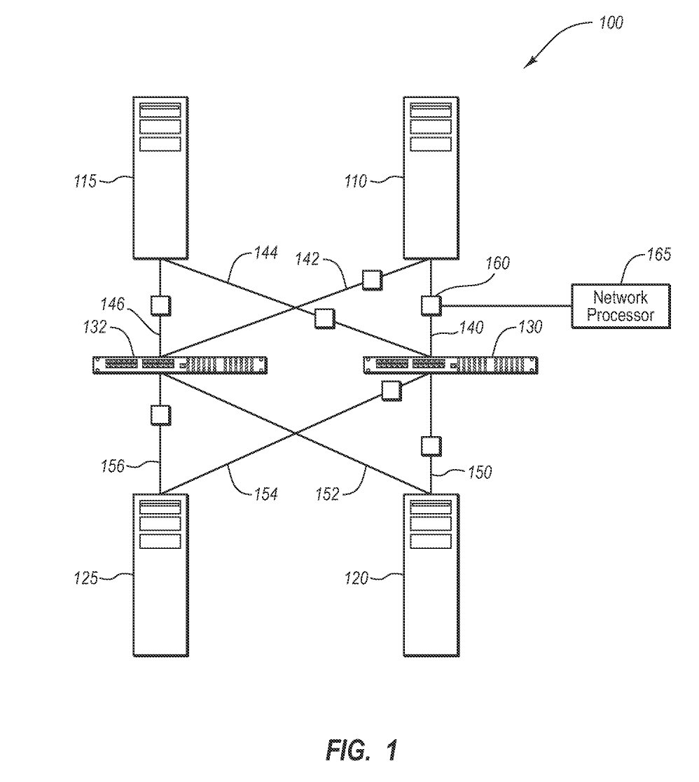

FIG. 1 illustrates a generalized schematic view of a simplified network 100 according to one example, such as a storage area network (SAN). The network generally includes a plurality of network devices, such as first network devices 110, 115 and second network devices 120, 125. One or more switches 130, 132 couples each of the network devices 110, 115, 120, 125 in the network together to allow the network devices 110, 115, 120, 125 to interact with each. In particular, in one example, the first network devices 110, 115 may be storage devices while the second network devices 120, 125 may be host devices. In such a configuration, the switch 130 may allow the host devices 120, 125 to access the storage devices 110, 115. This access may allow the host devices 120, 125 to read from and write to the storage devices 110, 115. Accordingly, the switch 130 is coupled to other devices on the network 100, such as the host devices 120, 125. The switch 130 directs to and/or from either or both of the host devices 120, 125 to the storage device 110 over the network 100.

More specifically, the data is transferred over network links. In particular, first segments 140, 142, 144, 146 connect storage devices 110, 115 to switches 130, 132 and second segments 150, 152, 154, 156 connect the second network devices 120, 125 to the switches 130, 132. While four network devices 110, 115, 120, 125 are shown and discussed in reference to FIG. 1, any number of network devices may be linked.

One or more traffic access ports (TAP) 160 may be used to monitor the flow of network traffic. The TAP 160 is configured to allow transfer of information between the first and second network devices 110, 115, 120, 125 while providing monitoring capabilities. In particular, the TAP 160 allows the information to flow freely between the storage device 110 and the switch 130, which may include information communicated between several devices. In one example, the information traveling over one of the first segments 140 may include information related to read and/or write processes between the storage device 110 and the host devices 120, 125. The location of the TAP 160 relative to the network is provided for illustration only. Any number of TAPs 160 may be located at any number of points within the network 100.

The mirrored data monitored by TAPs 160 is made available for use by other devices. For example, according to the illustrated example, each of the TAPs 160 provides the mirrored data to a network processor 165. The TAPs 160 are located in-line, such that the mirrored data directed to the network processor 165 provides a view of the traffic within the corresponding segment.

In one example, the network traffic flowing over the network is transmitted in packets. Each packet may include several parts, such as a header and a body. The packet header may include information used to transfer and direct the packet. The information used to transfer and direct the packet may include information such as which device sent the packet, the packet's final destination, whether the packet is part of a read request, a write request, or other type of request. The body of the packet may include the data that is to be transferred between the network device, such as information that is to be written to or read from a given device.

The network processor 165 may be configured to process the packets to provide statistics which may be useful in performing network monitoring and/or analysis, as described above. In one example, the network processor 165 may be configured analogously to a switch, such as an Ethernet switch. Such a switch may be adapted to process each network packet analogously to conventional network processing operations while being specifically configured to process the packets to provide statistical monitoring. In this sense, the advantages provided by the present invention could also be applied to switches 130, 132 to increase efficiency in processing network traffic or any other network device that could benefit from the teachings herein.

In such a configuration, the packets may be processed in several stages. Each stage may be configured to process the header to locate various types of information. Each stage may process several packets using parallel tasks. For example, a first stage may be used to determine that the information in the packet is valid. Another stage may be configured to determine the final destination of the packet as well as which network device sent the packets. Any number of stages may be used to process any number of informational items and, in some cases, track this information.

For example, this information may be used to provide information related to the location of network traffic jams and the cause or source of the traffic jams. In particular, the network processor 165 may receive data related to each link between devices in a network from a TAP 160 associated with that link. This data, when accumulated and plotted over time, provides insight for activities such as capacity planning. Capacity planning in a network may be aided by knowing information about the characteristics of traffic flow, such as location, time, and volume of traffic flow over each link, and by extension across the network 100.

As mentioned above, counters are one way of tracking this information. In particular, each packet that enters the network processor 165 is first directed to a staging process. The staging process determines to which stage each task should be directed. A staging process may be associated with each of the stages, and may be referred to generally as “kick code.” The packets are handled individually by each set of kick codes. For example, a packet first entering the network processor 165 enters the kick code. The kick code then evaluates flags or bits in the header and determines where to direct the data packet. The first set of kick codes may send the packet to the first stage. Each stage has several tasks running simultaneously. Several stages and kick codes will be discussed in more detail later.

Each task running in a stage processes the packet for particular information. In one example, once this information has been located and identified, the stage then updates a counter. As previously introduced, several tasks may be processing several packets in parallel. As a result, several tasks may find information around the same time and thus attempt to update the counter around the same time. In general, when a task increments a counter, the task reads the value of the counter, increments the value by one, and rewrites the new value to the counter. If the tasks were allowed to update the counter simultaneously, the counter may be inaccurate as two tasks may read the same number and write the same number back to the counter, resulting in incrementing the counter by one when it should have been incremented by two.

This is one example of difficulties that may be encountered if several processes simultaneously have access to the same counter. As mentioned above, in conventional systems, the counter may be locked by each task as the task updates the counter in order to maintain the accuracy of the counter. Locking the counter for each task to update the counter may slow down the system as such a system may take one or two cycles for the counter to become available. Consequently, a bottleneck may occur by locking the counters.

According to one example of the present invention, a process is provided wherein the kick code of each stage is configured to update one or more counters with the information gleaned from each packet from the processing performed in a previous stage. Since the kick code of each stage handles each packet in an individual fashion, the kick code is able to update the selected registers directly without locking. In particular, because each packet is handled individually by the kick code, the kick code is able to increment a counter without locking the counter because other processes are not competing to increment the counter. Once the counter has been updated, the kick code then processes the next packet, including updating the corresponding counters, if any, and routing the packet to the next appropriate stage. One example of the method of incrementing the counters using the kick code will now be discussed in more detail.

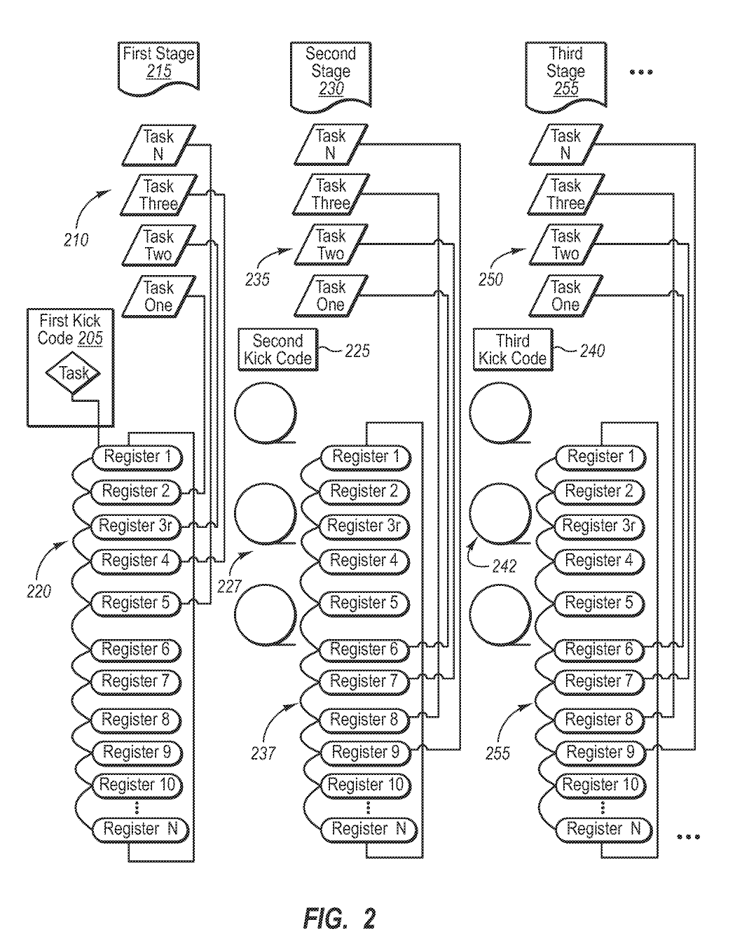

FIG. 2 is a schematic diagram illustrating the use of kick code to update registers according to one example. In general, kick code refers to instructions for determining which stage or stages in a multistage processing arrangement a packet should be sent. As discussed in more detail below, the kick code may be used to reduce congestion that may occur due to the locking mechanisms needed for read modified writes. In particular, the kick code generally processes packets individually. In one example, the kick code may be further configured to update one or more counters, such as statistical counters. Additionally, the kick code may be further configured to provide instructions for other tasks, processes, or the like to update the counters.

The flowchart will be discussed in the context of a network device. In particular, the example discussed in FIG. 2 will be discussed with reference to a network switch that is adapted to process network packets to provide statistical and other information about the network traffic. As illustrated in FIG. 2, within a switch, the software configured to receive packets from the network, such as from one or more TAPs (not shown). Each of the entering packets is associated with a first kick code 205. The first kick code 205 analyzes the header to determine where to send the packet.

The first kick code 205 may be configured to send the packet to be processed by first tasks 210 running within a first stage 215. The first stage 215 may be configured to determine whether the process in the packet is valid. Further, the first stage 215 may be configured to identify the header and to separate the header from the rest of the packet.

The first task 210 assigns the task to one of a group of a unique memory location. In one example, the unique memory location is a registers 220. Other unique memory locations may also be used. Each of the registers 220 is part of a bank of registers associated with a given task. Individual members of the same bank of registers are labeled similarly throughout the drawings. For example, a first bank of registers is labeled as register 1 throughout. The first task 210 may also reset or zero the register 220. The register 220 may be any data structure able to store results generated by one or more of the stages discussed below. In one example, the register 220 may be a double linked register, such as a double linked list. Any number of configurations may be utilized in which the switch is able to track progress of the packet. Each header and the corresponding tasks that process the data are assigned a single register. The use of a single register for each header that is processed by the switch reduces or eliminates the possibility that other tasks will access the register, thereby corrupting the register.

In addition to assigning registers, the first task 210 may be configured to provide other stages with instructions as to what the tasks should search for or process. The first task 210 is also configured to communicate its determinations to other stages to provide keys to other stages to allow the tasks running in those stages to write to the register.

Once one of the first tasks 210 is complete, the first task 210 directs the header to the second kick code 225. The second kick code 225 is configured to update one or more counters 227 according to the determinations made by the first task 210. In particular, the second kick code 225 may be configured to access the registers 220 associated with the header as it enters the second kick code 225. As previously mentioned, the register may have one or more bits or flags that are set based on determinations made in previous stages. The second kick code 225 checks these flags and updates the counter as appropriate. One or more of the counters may be configured to provide statistical information. The statistical information as well as other information gleaned from analysis of the packets may be used to monitor and/or analyze the performance of the network. Thus, the second kick code 225 may update counters 227 associated with the first registers 220. The second kick code 225 is also configured to determine which stage the header should be sent to for further processing.

As shown in FIG. 2, one of the stages to which the second kick code 225 may send the header is a second stage 230. At the second stage 230, each of the headers is associated with one of the second tasks 235. The second tasks 235 may be configured to look up data as indicated by the first stage 215. For example, the second tasks 235 may be configured to identify media access control (MAC) addresses of the host and destination devices and to compare the MAC addresses to known addresses. If the MAC addresses are located, the second task 235 may then update one or more bit or fields in the second registers 237. Each bit that is incremented in the second registers 237 may correspond with a specific counter that is to be updated. For example, setting a register associated with identifying host machines will set a bit in the register indicating the host machine counter should be incremented. The second task 235 may be configured to search for other data as desired.

Once one of the second tasks 235 has finished processing, the header is sent to kick code. In one example, upon finishing the second task 235, it sent the header to a third kick code 240. The third kick code 240 is configured to check the register 237 associated with the header.

In particular, the third kick code 240 is configured to update the counter 227 according to the determinations made by the second task 235. In particular, the third kick code 240 may be configured to access the register 237 associated with the header as it enters the third kick code 240. The second kick code 225 checks these flags and updates the counter as appropriate.

In one example, the third kick code 240 receives the header from the second tasks 235 running in the second stage 230. The second tasks 235 may be configured to identify the host device and the destination device. The second tasks 235 note this information by setting flags in the registers 237. The third kick code 240 then accesses the registers 237 in order to determine which counters 242 to update.

Each of the kick codes may be configured to process one packet at a time. Further, each kick code is configured to update counters that other processes are not able to increment. These other processes specifically include other instances of the kick code. As a result, when the kick code updates or increments a counter, the kick code is able to do so directly because the kick code is the only process updating the counter. Further, each of the kick codes may be configured to process each packet individually, such as one at a time. Such a configuration substantially reduces or even eliminates the likelihood that the counter will be corrupted.

In addition to updating the appropriate counters based on the bit flags set in the register, the third kick code 240 also determines to which stage to send the header. The third kick code 240 may determine which stage to send the header based on the criteria determined in the first stage 215. The third kick code 240 may be configured to determine which of the criteria have already been met by the second task 235 running in the second stage 230.

The third kick code 240 may also be configured to determine which of the remaining criteria may be met by processing in subsequent stages. Once the third kick code 240 has determined to which stage the header should be sent, the third kick code 240 then sends the header to the appropriate stage.

In one example, the third kick code 240 may send the header to a third stage, where the header is associated with one of several third tasks. In one example, the third stage receives instructions for the queries to be performed from first stage 215 as well as the results from the second stage 230. The third tasks 250 may then determine the nature of the header. In particular, the third tasks may be configured to determine whether the original packet included a write command or a read request. If the third tasks 250 determine whether the header indicated a read or a write command, that determination may be noted by setting a flag in the registers 255.

The third tasks send the header on for further processing to a set of fourth kick code. The fourth kick code accesses the registers and updates the corresponding counters as appropriate, such as by updating the read and write counters. The fourth kick code also determines to which of the stages to direct the header.

One of the available stages may include a fourth stage in which fourth tasks may be running. The fourth tasks may be configured to search the results of searches or operations performed in previous stages. In particular, the fourth tasks may be able to search the results of other stages to determine whether the header indicates that a read or write operation has completed. Each read/write operation may be made up of several packets that are transmitted separately over a network. Additionally, the first stage 215 could also determine if a command had completed as it could have on the tree in memory leafs for each packet of a command. The command header would note that it was the last packet of command thus the stage would know this. However, if a packet was a re-transmitted packet because of an error, a forth stage could be used to count retransmitted packets, time delays between logging leafs, and time between first packet command start and last packet command complete.

The information identifying the devices may be used to indicate between which devices the information is flowing. Additionally, when such an operation begins, the header may include an indication that the operation is open. While the operation is open, the headers will continue to include an indication to that effect. Once the operation is complete, the sending device sends a close indication to indicate that the operation is finished. Accordingly, the fourth tasks may be configured to access the results of several stages to determine whether a read or write operation is being performed and between which devices.

If one of the fourth tasks determines that the header is part of an operation that is just beginning, the fourth tasks may be configured to set a flag bit in register corresponding to a new process. Further, the fourth tasks may determine that the header was part of a process already underway. In particular, the fourth tasks may be configured to count the number of packets used for a given process. For example, the fourth tasks may determine the packet is an intermediate packet in a read/write operation. If the fourth tasks make such a determination, the fourth tasks may be configured to set a bit flag in the register indicating that another packet has been received while not incrementing the active operation bit flag indicating a separate process. If the fourth task determines that the header indicates a close, the fourth task may set a bit flag in the corresponding register to decrease the number of open operations.

Several stages have been discussed that process the header to determine several characteristics about the network traffic. The stages and kick code have been discussed sequentially. In addition, the kick code may be able to direct the headers to any of the stages in any order. Further, additional stages with additional tasks, registers, and counters may be used to search for any number of additional information within data packets.

Embodiments of the device may include computer-readable media for carrying or having computer-executable instructions or data structures stored thereon. Such computer-readable media can be any available media that can be accessed by a portable device or general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a portable device or general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Although not required, the invention may be described in the general context of computer-executable instructions, such as program modules, being executed by computers in network environments. Generally, program modules include acts, routines, programs, objects, components, data structures, etc. that perform particular tasks or implement particular abstract data types. Computer-executable instructions, associated data structures, and program modules represent examples of the program code means for executing acts of the methods disclosed herein. The particular sequence of such executable instructions or associated data structures represents examples of corresponding acts for implementing the functions described in such acts.

The devices may also include a magnetic hard disk drive for reading from and writing to a magnetic hard disk, a magnetic disk drive for reading from or writing to a removable magnetic disk, or an optical disk drive for reading from or writing to removable optical disks such as a CD-ROM or other optical media. The device may also include non-volatile memory including flash memory. The drives and their associated computer-readable media provide nonvolatile storage of computer-executable instructions, data structures, program modules and other data. Although the exemplary environment described herein may employ a magnetic hard disk, a removable magnetic disk and/or a removable optical disk, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk, magnetic disk, optical disk, ROM or RAM, including an operating system, one or more application programs, other program modules, and program data. A user may enter commands and information through a keyboard, pointing device, or other input devices (not shown), such as a microphone, joy stick, touch pad, game pad, satellite dish, scanner, or the like. These and other input devices are often connected to the processing unit through a universal serial bus (USB) or serial port interface coupled to system bus. Alternatively, the input devices may be connected by other interfaces, such as a parallel port, or a game port. A display device is also connected to system bus via an interface, such as a video adapter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method comprising:
receiving a first data packet at a first kick code from a first stage, the kick code being configured to process data packets individually and the first stage being configured to perform one or more tasks;
updating one or more counters using the first kick code based on determinations made in the one or more tasks performed at the first stage; and
directing the first data packet to a another stage.

2. The method of claim 1, wherein the step of receiving a data packet includes receiving a network packet flowing over a network.

3. The method of claim 2, wherein the step of receiving network packets flowing over a network includes receiving network packets within a network device.

4. The method of claim 3, wherein the step of receiving a network packet with a network device includes receiving network packets within a network switch.

5. The method of claim 2, wherein the step of receiving a network packet flowing over a network includes receiving a network packet from one or more traffic access points.

6. The method of claim 2, wherein the step of receiving a data packet includes receiving a network packet flowing over a storage area network.

7. The method of claim 1, and further comprising the step of assigning the data packet to at least one unique memory location.

8. The method of claim 7, and further comprising the steps of setting a bit flag in each unique memory location corresponding to determinations of one or more task.

9. The method of claim 8, wherein the kick code processes the bit flags to update the one or more counters.

10. The method of claim 1, wherein the step of updating the one or more counters includes updating one or more statistical counters.

11. The method of claim 1, wherein the step of directing the data packets to a plurality of stages includes directing the packets to stages configured to parse the data, determine the host device and destination device, determine read/write commands; and determine open/close commands.

12. A computer readable medium having computer readable instructions stored thereon for performing a method, wherein the method comprises:
receiving network packets,
assigning each of the network packets to a unique memory location;
directing at least one of the network packets to one of a plurality of stages using a first kick code, each stage having a plurality of tasks running therein;
setting a flag in one or more unique memory locations based on determinations made in one or more of the plurality of tasks; and
updating one or more counters using the first kick code based on the flag.

13. The computer readable medium of claim 12, wherein receiving the network packets includes receiving network packet having a header and a body, and further comprising stripping the header from the network packet.

14. The computer readable medium of claim 12, wherein the step of receiving network packets includes receiving network packets using a network device.

15. The computer readable medium of claim 14, wherein the step of receiving network packets using a network device includes receiving network packets using a network switch.

16. The computer readable medium of claim 12, wherein the step of updating counters includes updating counters that correspond to network statistical information.

17. The computer readable medium of claim 15, wherein the step of updating counters includes updating counters that correspond to network statistical information.

18. A network device, comprising:
a computer readable medium, the computer readable medium comprising instructions for performing a method, the method comprising:
receiving network packets,
assigning each of the network packets to a unique memory location;
directing the packet to one of a plurality of stages using kick code, each stage having a plurality of tasks running therein;
setting a flag in one or more unique memory locations based on determinations made in the task; and
updating one or more counters using the kick code based on the flag.

19. The network device of claim 18, wherein the network device comprises a network switch.

20. The network device of claim 18, wherein the network device is configured to receive network packets from one or more traffic access port.
